(19) United States
(12) Patent Application Publication
(10) Pub. No.: US 2004/0095306 A1
(43) Pub. Date: May 20, 2004

(54) Driving circuit for driving capacitive element with reduced power loss in output stage

(75) Inventor: Tatsumi Fujiyoshi, Miyagi-ken (JP)

Correspondence Address: BEYER WEAVER & THOMAS LLP, P.O. BOX 778, BERKELEY, CA, 94704-0778, US

(73) Assignee: ALPS ELECTRIC CO., LTD.

(21) Appl. No.: 10/693,427

(22) Filed: Oct. 23, 2003

(30) Foreign Application Priority Data
Nov. 14, 2002 (JP) 2002-330470

(51) Int. Cl. G09G 3/36

(52) U.S. Cl. 345/94

(57) ABSTRACT

A first comparator circuit compares an input voltage from a D/A converter with an output voltage. A second comparator compares the input voltage with a predetermined reference voltage. The second comparator circuit includes an even number of stages of inverters, which are connected together, and analog switches. In the second comparator circuit, the input voltage is quickly input just before the initialization, and then a first analog switch is opened and a second switch is closed, thereby suppressing the power consumption. A switch control circuit controls switching of switches, i.e., from a third switch to a tenth switch, in accordance with the determination output of the second comparator circuit, a write signal, and an output initialization signal.

### BACKGROUND OF THE INVENTION

1. Field of the Invention

The present invention relates to a driving circuit for driving a liquid crystal display unit, and in particular, to a driving circuit for driving a capacitive element.

2. Description of the Related Art

There have been demands for low-power driving circuits in portable thin film transistor liquid crystal displays (hereinafter referred to as TFT-LCD). As disclosed in Japanese Unexamined Patent Application Publication Nos. 9-18253 and 9-64662, an operational amplifier is mainly used for an output stage of the driving circuit in a source driver of the TFT-LCD.

Referring to FIG. 10, the TFT-LCD includes scanning lines 51, data lines 52, thin film transistors 53, pixel electrodes 54, and counter electrodes (not shown in the figure). A liquid crystal layer is disposed between the pixel electrodes 54 and the counter electrodes. In the TFT-LCD, each of the scanning lines 51 is selected by a gate driver 56 in order, and a source driver 57 sends an analog signal to each of the data lines 52.

In response to a timing controller 55, the source driver 57 distributes a digital signal, which is multiplexed by a shift register-data latch 58, to each channel. In the source driver 57, the signal is subjected to digital-to-analog conversion by an R-String 59 and a D/A converter 60, and is sent to each of the data lines 52 through a buffer 61. The buffer 61 is required for rapidly driving each of the data lines 52, which has a capacitive load.

In view of the image quality, accurate electric potentials must be applied to the liquid crystal display unit. Referring to FIG. 9, an operational amplifier, which uses a differential amplifier, is used for a circuit of the output stage, i.e., current amplification stage (for example, see Japanese Unexamined Patent Application Publication No. 2000-338461).

In the circuit including the operational amplifier, a bias current needs to flow to the differential stage and the buffer stage. In particular, a constant-current I needs to flow to the buffer stage. Unfortunately, the circuit is class A or class AB in operation and has low power efficiency. The electrical power applied to the output stage must be several times the electrical power for actually driving the loads.

In fact, about 20% to 40% of the electrical power applied to the source driver is supplied to the output loads, that is, most of the electric power is lost in the output stage.

### SUMMARY OF THE INVENTION

In view of the above problems, it is an object of the present invention to provide a driving circuit for driving a capacitive element with reduced power loss in the output stage of a source driver in a liquid crystal display unit, thereby achieving low electrical power consumption in the source driver and thus in the entire liquid crystal display unit.

In order to solve the above problem, according to an aspect of the present invention, a driving circuit for driving a capacitive element according to an input voltage includes a first constant-current source for supplying a current from a first power supply to the capacitive element; a second constant-current source for supplying the current from the capacitive element to a second power supply; a first comparative device for comparing the input voltage with an output voltage to be supplied to the capacitive element; a second comparative device for comparing the input voltage with a predetermined reference voltage; and a control device for charging or discharging the capacitive element through the first power supply or the second power supply based on the result of the comparison of the second comparative device, charging or discharging the capacitive element through the first constant-current source or the second constant-current source based on the result of the comparison of the first comparative device, and holding a charging voltage of the capacitive element when the charging voltage of the capacitive element reaches the input voltage.

The driving circuit for driving a capacitive element preferably includes a first switching device for opening and closing a path between the first constant-current source and the capacitive element; a second switching device for opening and closing a path between the second constant-current source and the capacitive element; a third switching device for opening and closing a path between the capacitive element and the first power supply; and a fourth switching device for opening and closing a path between the capacitive element and the second power supply; wherein the control device controls the opening and closing of the third switching device and the fourth switching device based on the result of the comparison of the second comparative device to charge or discharge the capacitive element through the first power supply or the second power supply, controls the opening and closing of the first switching device and the second switching device based on the result of the comparison of the first comparative device to charge or discharge the voltage of the capacitive element through the first constant-current source or the second constant-current source, and holds the charging voltage of the capacitive element when the charging voltage of the capacitive element reaches the input voltage.

The first comparative device is preferably composed of a switched comparator including an inverter and a capacitor which holds a differential voltage between the input voltage and a logical threshold voltage of the inverter.

The second comparative device preferably includes an inverter for inverting the input voltage and analog switches for supplying and not supplying the inverter with an input signal.

The reference voltage is preferably a midpoint potential between the first power supply and the second power supply.

The first comparative device is preferably composed of a switched comparator including a variable logical threshold inverter.

According to the present invention, the control device charges or discharges the capacitive element through the first power supply or the second power supply based on the result of the comparison of the second comparative device, and charges or discharges the capacitive element through the first constant-current source or the second constant-current source based on the result of the comparison of the first comparative device, and holds the voltage of the capacitive element when the charging voltage of the capacitive element reaches the input voltage. Accordingly, the power loss in the output stage of a source driver in a liquid crystal display unit can be reduced, thereby achieving low electrical power consumption in the source driver and thus in the entire liquid crystal display unit.

### BRIEF DESCRIPTION OF THE DRAWINGS

FIG. 1 is a block diagram of an output stage circuit (i.e., buffer) of a source driver according to a first embodiment of the present invention;

FIG. 2 is a circuit diagram of the output stage circuit of the source driver according to the first embodiment of the present invention;

FIGS. 3A and 3B are circuit diagrams for illustrating the operation of a switched comparator circuit which is a component of a first comparator circuit 10;

FIG. 4 is a timing chart for illustrating the operation of the output stage circuit of the source driver according to the first embodiment of the present invention;

FIG. 5 is a conceptual diagram illustrating voltage waveforms at each part in the driving circuit according to the first embodiment of the present invention;

FIG. 6 is a conceptual diagram illustrating voltage waveforms at each part in the driving circuit according to the first embodiment of the present invention;

FIG. 7A is a circuit diagram of a typical inverter;

FIG. 7B is a circuit diagram of an inverter which is a component of a switched comparator;

FIG. 8A illustrates input and output voltage waveforms in the operation when using a typical inverter;

FIG. 8B illustrates input and output voltage waveforms in the operation when using a variable threshold inverter;

FIG. 9 is an equivalent circuit diagram of a buffer circuit (i.e., output stage circuit) in a known liquid crystal display unit; and

FIG. 10 is a block diagram illustrating a driving circuit in a typical liquid crystal display unit.

### DESCRIPTION OF THE PREFERRED EMBODIMENTS

Embodiments of the present invention will now be described with reference to the drawings.

### First Embodiment

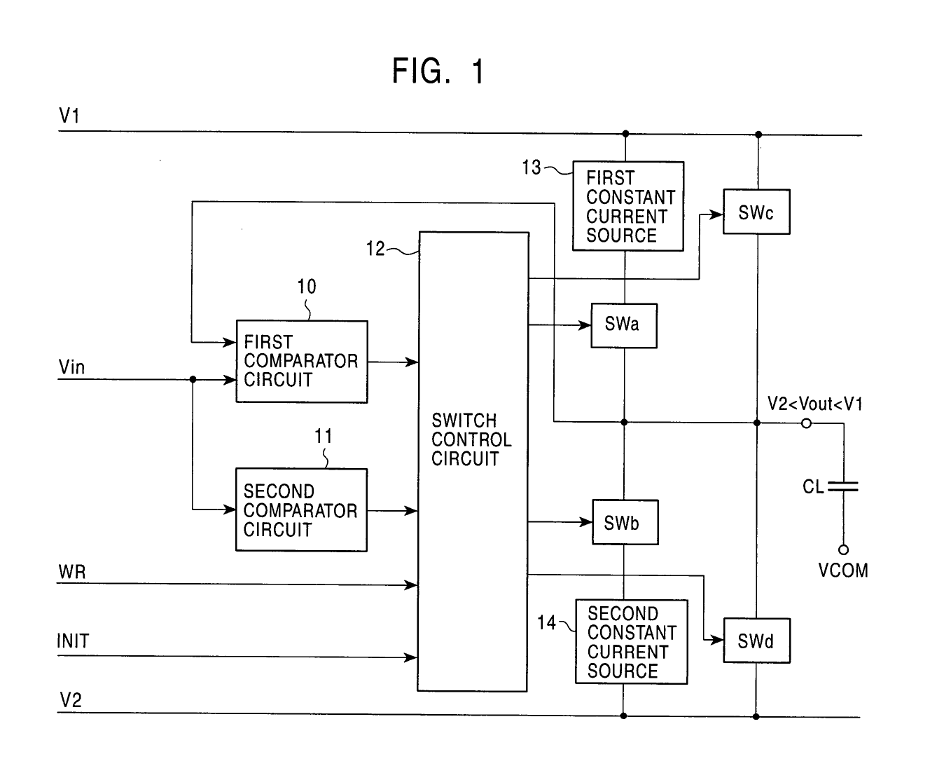

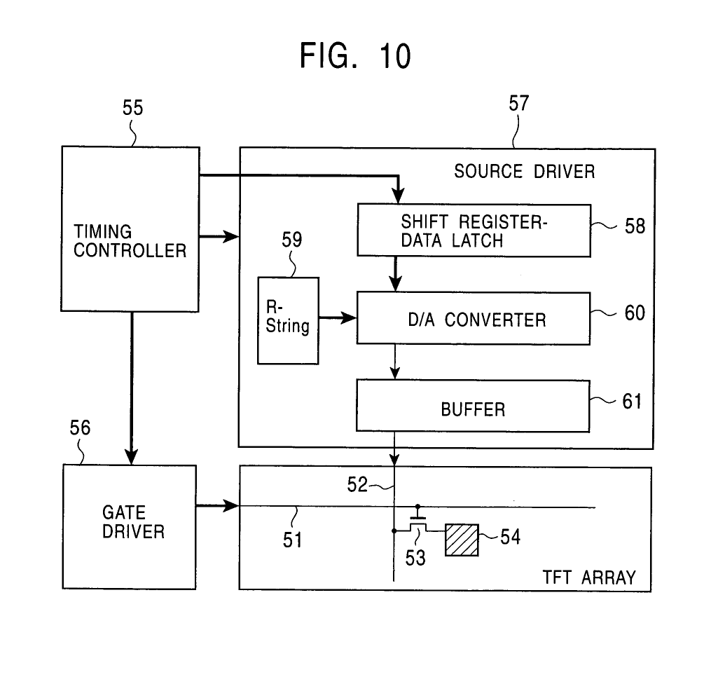

FIG. 1 is a block diagram of an output stage circuit (i.e., buffer) of a source driver according to a first embodiment of the present invention. Referring to FIG. 1, a first comparator circuit 10 compares an input voltage, i.e., Vin, which is an output from a D/A converter 60 (see FIG. 10), with an output voltage, i.e., Vout. A second comparator circuit 11 determines whether the input voltage Vin is higher or lower than the midpoint of the output voltage Vout. A switch control circuit 12 controls switching of switches SWa, SWb, SWc, and SWd, in accordance with the determination output of the first comparator circuit 10, the determination output of the second comparator circuit 11, a write signal WR, and an output initialization signal INIT. The switches SWa and SWb establish connection/disconnection to the outputs of a first constant-current source 13 and a second constant-current source 14 in accordance with the control of the switch control circuit 12. The switches SWc and SWd establish connection/disconnection to the outputs of a first power supply V1 and a second power supply V2 in accordance with the control of the switch control circuit 12. A symbol CL indicates a load capacitor having the capacitance per source wiring line. A symbol VCOM indicates the electrical potential of a counter electrode in a liquid crystal panel.

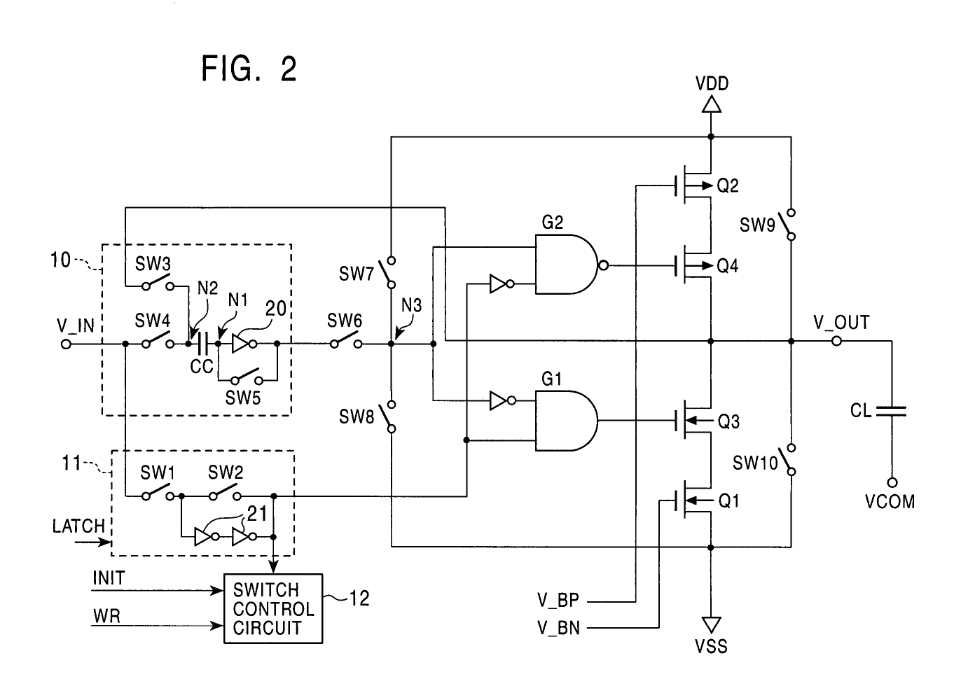

FIG. 2 is a circuit diagram of the output stage circuit of the source driver according to the first embodiment of the present invention. Some parts corresponding to FIG. 1 have the same reference numerals and symbols, and are not described. A voltage, i.e., V_IN, from the D/A converter 60 (see FIG. 10) is input to the first comparator circuit 10 and the second comparator circuit 11. An input determination signal LATCH is also input to the second comparator circuit 11. The output of the second comparator circuit 11, the output initialization signal INIT, and the write signal WR are input to the switch control circuit 12.

Switches SW3, SW4, SW5, SW6, SW7, SW8, SW9, and SW10 open and close in accordance with the signals from the switch control circuit 12. Transistors Q1 and Q2 are operated as the constant-current sources and bias voltages V_BN and V_BP are applied to their gate terminals. Switching of transistors Q3 and Q4 is controlled by gate circuits G1 and G2 in accordance with the outputs of the first comparator circuit 10 and the second comparator circuit 11.

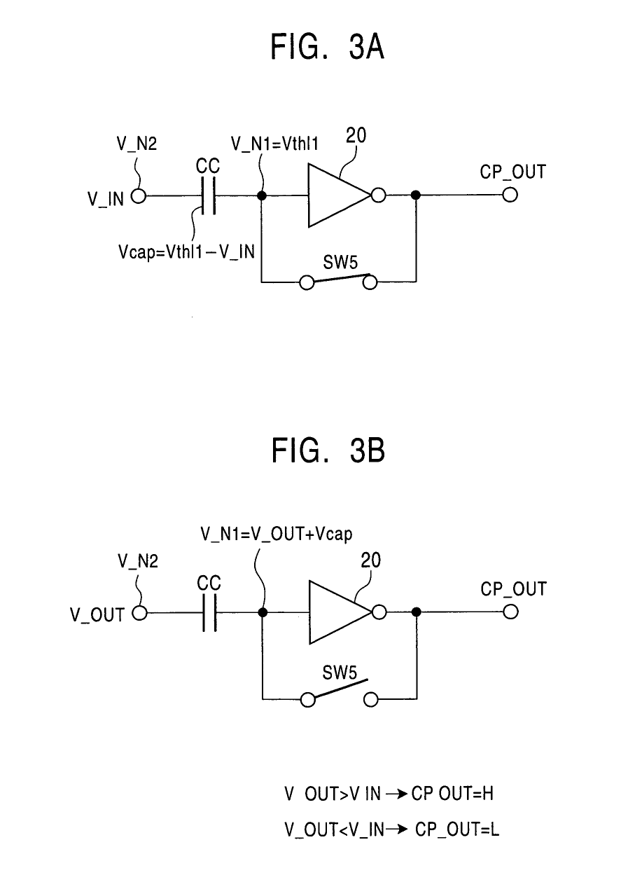

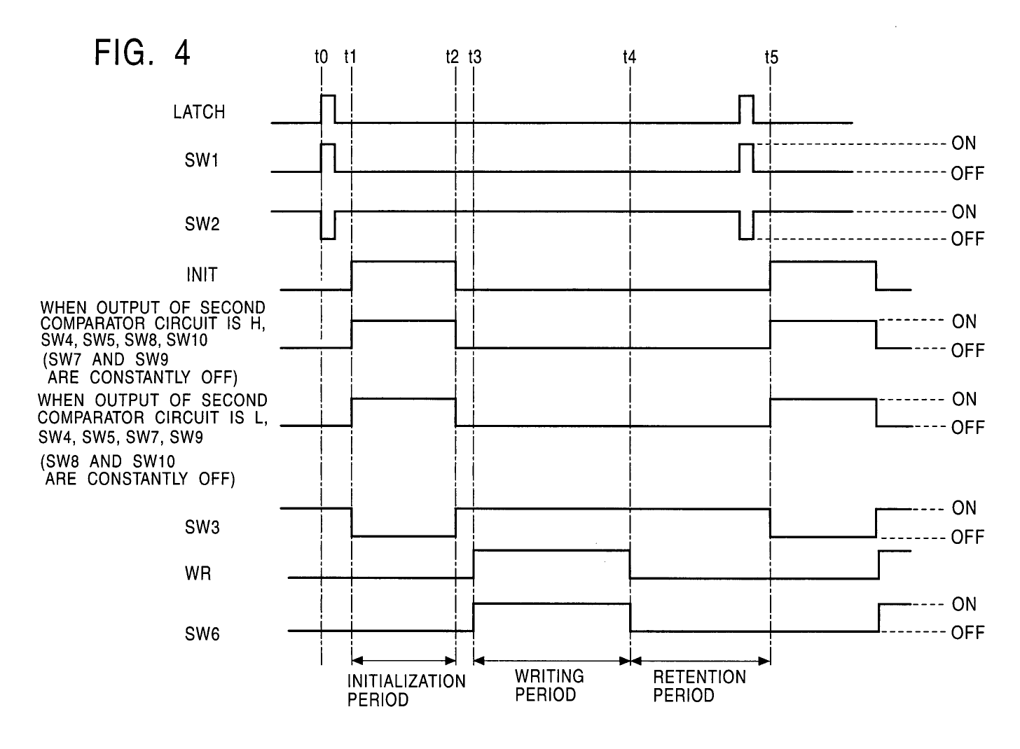

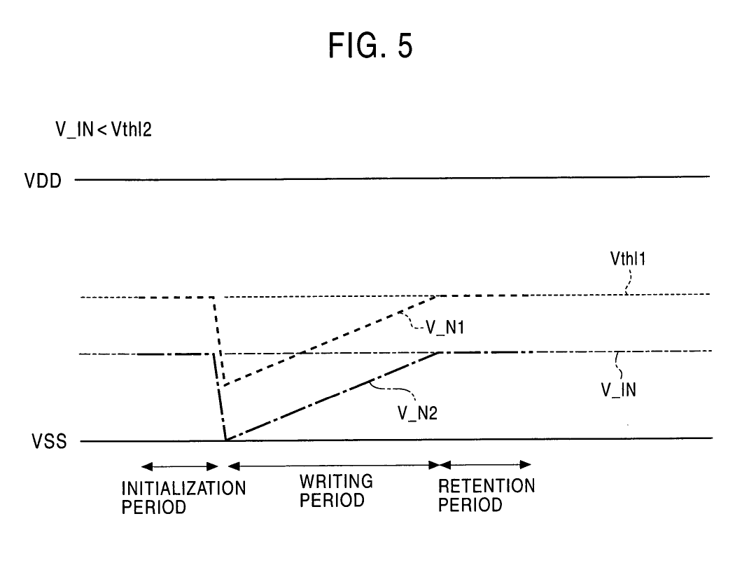

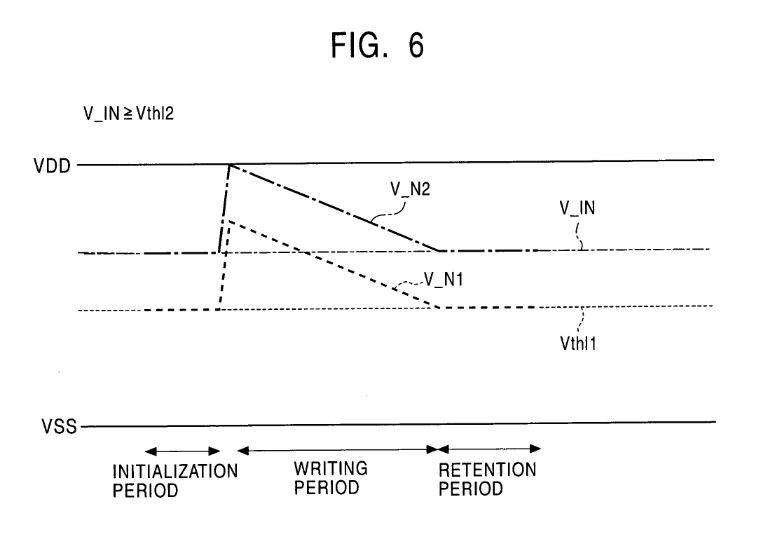

The operation of the circuit according to the first embodiment will now be described. FIGS. 3A and 3B are circuit diagrams for illustrating the operation of a switched comparator circuit which is a component of the first comparator circuit 10. FIG. 4 is a timing chart for illustrating the operation of the output stage circuit of the source driver according to the first embodiment of the present invention. FIGS. 5 and 6 are conceptual diagrams illustrating voltage waveforms at each part in the driving circuit according to the first embodiment of the present invention. The operation of the driving circuit depends on the input voltage V_IN, specifically, whether the input voltage V_IN is less than a logical threshold voltage Vthl2 of an inverter used in the second comparator circuit 11 or greater than or equal to the logical threshold voltage Vthl2 of an inverter used in the second comparator circuit 11. FIG. 5 illustrates the operation in the case where the voltage V_IN is less than the voltage Vthl2, and FIG. 6 illustrates the operation in the case where the voltage V_IN is greater than or equal to the voltage Vthl2.

The operation in the case where the voltage V_IN is less than the voltage Vthl2 is described with reference to FIGS. 2, 3A, 3B, 4, 5, and 10. An output sequence is divided into an initialization period, a writing period, and a retention period. In a source driver 57, digital data corresponding to one scanning line is input, data to be output is determined, the data is subjected to digital-to-analog conversion by the D/A converter 60, and an analog voltage to be written to the corresponding pixel is input as the voltage V_IN. The voltage V_IN is stabilized, and then the input determination signal LATCH becomes active in the second comparator circuit 11, the switch SW1 is closed, the switch SW2 is opened, and then the voltage V_IN is input in the second comparator circuit 11 (see time t0 in FIG. 4). The input is performed at the end of the retention period and just before the initialization period.

When the input voltage V_IN is less than the logical threshold voltage Vthl2 of the inverter 21 in the second comparator circuit 11, the output of the second comparator circuit 11 is low, i.e., L. On the other hand, when the input voltage V_IN is greater than or equal to the Vthl2, the output of the second comparator circuit 11 is high, i.e., H. First, a case where the voltage V_IN is less than the voltage Vthl2 will now be described. In this case, the output of the second comparator circuit 11 is L. If the voltage V_IN is close to a voltage which is less than the voltage Vthl2, a relatively large amount of through current flows in the first stage inverter in the second comparator circuit 11. In this case, wasteful electrical power is consumed. In order to avoid wasteful electrical power consumption, a plurality of inverters is connected such that the inverter 21 has an even number of stages, thereby securing sufficient gain, and feedback to the input is performed by using the switch SW2. As described above, the switch SW1 is closed only while the input determination signal LATCH is active, thereby quickly inputting the input voltage V_IN. Then the switch SW1 is opened and the switch SW2 is closed, thereby suppressing the power consumption. After that, this state is maintained until the subsequent sequence is performed.

Then the initialization signal INIT becomes active, thereby closing the switches SW4, SW5, SW8, and SW10 (see time t1 in FIG. 4). Other switches except the switch SW2 are opened. Referring to FIG. 2, since the output of the second comparator circuit 11 is L, the transistor Q3 is in the off state. Since the switch SW8 is closed, the electrical potential at a point N3 has a voltage of the second power supply, i.e., VSS, and the transistor Q4 is in the off state. The switch SW10 is closed; therefore, a point V_OUT has the voltage VSS.

The operation of the first comparator circuit 10 is as follows: when the switches SW4 and SW5 are closed, a point N1 has a logical threshold voltage Vthl1 of the inverter in the first comparator circuit 10. Accordingly, referring to FIG. 3A, a capacitor CC has a voltage Vcap, which is the difference between the logical threshold voltage Vthl1 of the inverter used in the first comparator circuit 10 and the input voltage V_IN (i.e., Vcap=Vthl1-V_IN).

Then the initialization signal INIT becomes inactive, thereby opening the switches SW4, SW5, SW8, and SW10, and closing the switch SW3 (see time t2 in FIG. 4). Since the switch SW4 is opened and the switch SW3 is closed, the input point in the first comparator circuit 10 has the voltage V_OUT. As described above, the point V_OUT has the voltage VSS according to the initialization. Since the capacitor CC holds the voltage Vcap described above, referring to FIG. 3B, the voltage V_N1 is represented by adding V_OUT to Vcap (i.e., V_N1=V_OUT+Vcap). In this case, an output CP_OUT is high, i.e., H.

Then the write signal WR becomes active and the switch SW6 is closed (see time t3 in FIG. 4). In this case, the point N3 has a voltage of the first power supply, i.e., VDD. Accordingly, the transistor Q4 (i.e., the constant-current source) enters the on state and is connected to the point V_OUT, thereby supplying the load capacitor CL with electrical charge. During this period, the switch SW3 is closed; therefore, the point V_OUT has the voltage V_2, i.e., V_OUT=V_N2. Referring to FIG. 5, electric charge is supplied by the transistor Q4 (the constant-current source), accordingly, the voltage V_OUT increases with a constant gradient from the initial voltage VSS. As in the voltage at the point V_N2, the voltage at the point V_N1 is also increases while maintaining the voltage difference Vcap.

The transistor Q2 (i.e., the constant-current source) supplies the load capacitor CL with electric charge, thereby increasing the voltage V_OUT. When the voltage V_OUT, which is equal to the voltage V_N2, becomes equal to the voltage V_IN, the point V_N1 has the logical threshold voltage Vthl1 in the second comparator circuit 11. Then the output of the second comparator circuit 11 turns from high, i.e., H to low, i.e., L.

When the output of the second comparator circuit 11 turns to low, i.e., L, the transistor Q4 enters the off state. Accordingly, the path between the transistor Q2 (the constant-current source) and the point V_OUT is interrupted. When the point V_OUT has the voltage V_IN, the writing is finished and the retention period begins (see time t4 in FIG. 4). During the retention period, the point V_OUT maintains the voltage V_IN until the initialization of the subsequent writing sequence is performed. In fact, the writing in the pixels of the LCD panel can be performed during the writing period and the retention period by turning the TFTs of the pixels on. The amount of current from the constant-current source depends on the load capacitance of the capacitor CL, and is set so as to have a value having some margins in view of, for example, the differences between devices and temperature changes.

When the retention period is completed (see time t5 in FIG. 4), the sequence to write the subsequent scanning line is repeated. FIG. 6 illustrates the relationship between the electrical potentials in the case where the voltage V_IN is greater than or equal to the voltage Vthl2. When the initialization signal INIT becomes active, the switches SW4, SW5, SW7, and SW9 are closed in accordance with the control of the switch control circuit 12. In this case, the point V_OUT has the voltage VDD according to the initialization.

According to the first embodiment, use of the circuit mainly operated by the switches SW can suppress the bias current and the through current as much as possible. In driving a TFT panel corresponding to a quarter video graphic array (QVGA), the electric power consumption in the output stage is about 18 mW, i.e., the electric power consumption can be reduced by 40% compared with a known art.

### Second Embodiment

A second embodiment of the present invention will now be described. According to the first embodiment, a switched comparator is used in the first comparator circuit 10 and it is important that the through current be reduced as much as possible. In that case, the delay time of the switched comparator, due to the decreasing of the through current, may be a problem.

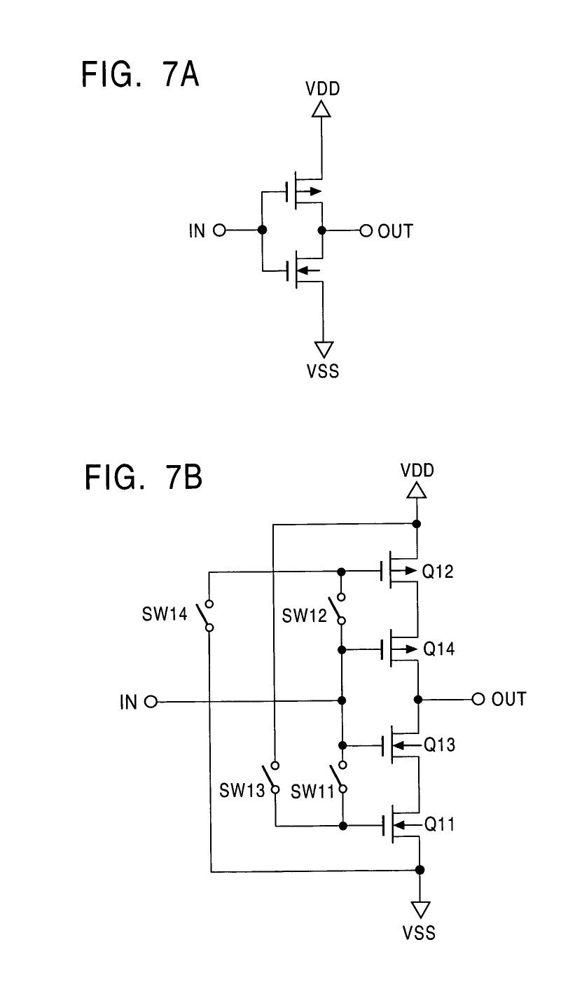

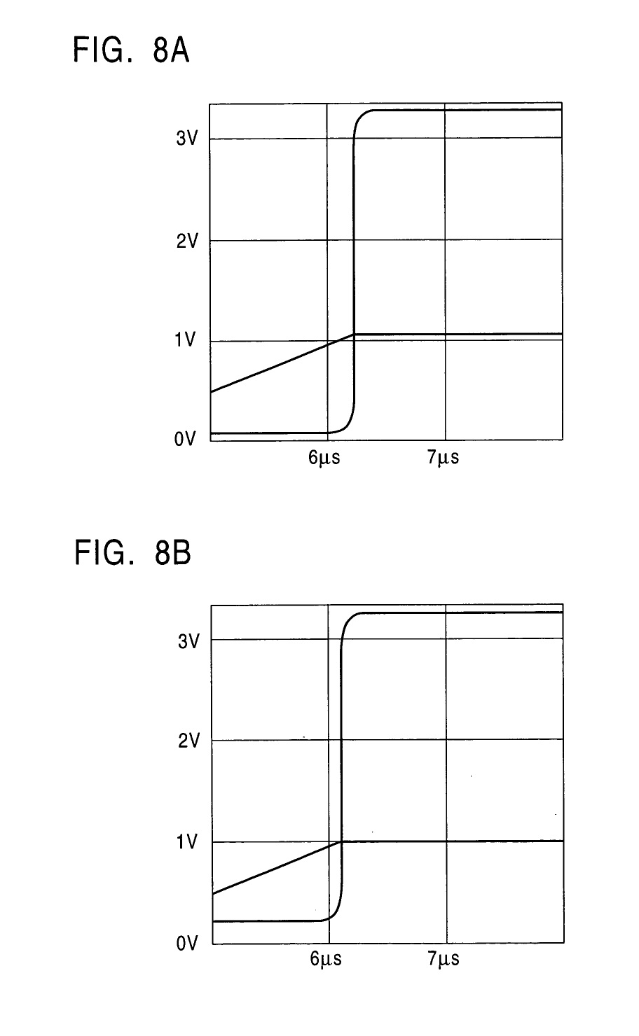

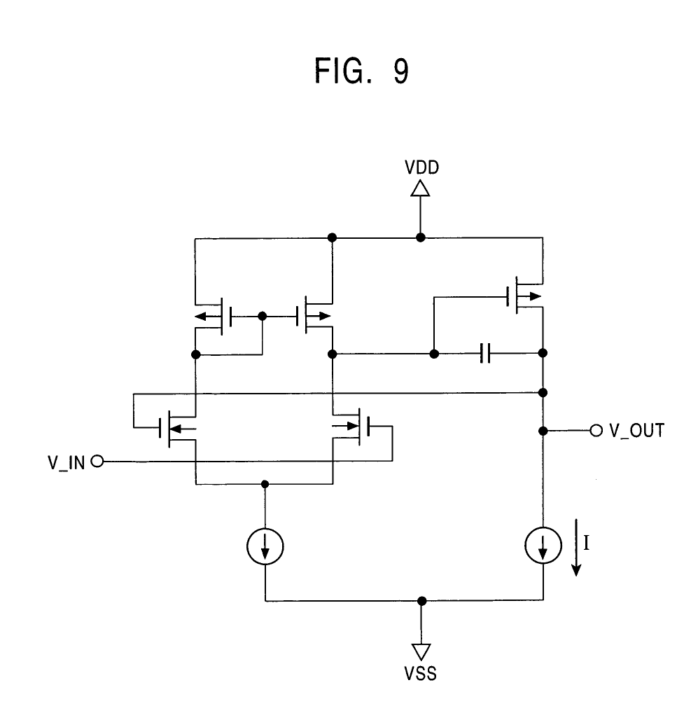

FIG. 8A illustrates input and output voltage waveforms in the operation when using a typical inverter. The input voltage is 1 V. In this case, the timing to interrupt the path between the constant-current source and the load capacitor CL is delayed because of the delay of the switched comparator operation. As a result, the output voltage exceeds the input voltage, thereby generating an offset voltage. In order to compensate for this delay, a switched comparator according the second embodiment includes an inverter illustrated in FIG. 7B. FIG. 7B is a circuit diagram illustrating the inverter according the second embodiment. FIG. 7A is a circuit diagram illustrating the typical inverter. Referring to FIG. 7B, an n-channel transistor Q13 and a p-channel transistor Q14 correspond to the transistors in the inverter illustrated in FIG. 7A. A transistor Q11 and a transistor Q12 are connected to the transistor Q13 and the transistor Q14 in series, thereby allowing the logical threshold of the inverter to be variable.

The operation of the inverter in FIG. 7B will now be described. When the voltage V_IN is less than the voltage Vthl2, the switches SW11 and SW14 are closed during the initialization period. If the transistor Q11, which is disposed at the side of the n-channel transistor, and the transistor Q13 have the same gate width W, both of the transistors can be substantially assumed to be a single transistor having a ratio W/L′: wherein L′ represents the sum of the gate lengths of the transistor Q11 and the transistor Q13. With regard to the side of the p-channel transistor, the transistor Q12 is in the on state; therefore, the transistors can be assumed to be a single transistor Q14.

During the writing period, the switches SW12 and SW13 are closed. Accordingly, the gate length L of the transistors disposed at the p-channel side is substantially larger than that at initialization and the gate length L of the transistors disposed at the n-channel side is substantially smaller than that at initialization. The logical threshold of the inverter depends on the ratio W/L of the n-channel transistor and the ratio W/L of the p-channel transistor. Upon assuming the circuit illustrated in FIG. 7B to be a single inverter, the logical threshold in the writing period Vthl′ can be smaller than the logical threshold in the initialization period Vthl1. Accordingly, the output voltage changes like a ramp function, thereby enabling the switched comparator to invert earlier. FIG. 8B illustrates input and output voltage waveforms in the operation when using the variable threshold inverter described above. This structure allows the delay in the switched comparator to be compensated for.

According to the first and the second embodiments described above, a driving circuit wherein a bias current and a through current do not flow can be produced, thereby achieving a low-power device. The first comparator circuit 10 is composed of a switched comparator including an inverter, and a capacitor which holds a difference voltage between the input voltage and the logical threshold voltage of the inverter, thereby achieving a low power and a small scale driving circuit. The second comparator circuit 11 includes an inverter for inverting an input signal and analog switches for supplying/not supplying the inverter with the input signal, thereby achieving a low power and a small scale driving circuit. Furthermore, in the second comparator circuit 11, the midpoint electrical potential between the voltage of a first power supply VDD and the voltage of the second power supply VSS is set as a reference voltage, and the reference voltage is compared with the input voltage. Accordingly, the power loss in the output initialization can be minimized. Furthermore, the first comparator circuit 10 is composed of the switched comparator including a variable logical threshold inverter, thereby decreasing the offset voltage of the input and the output.

What is claimed is:

1. A driving circuit for driving a capacitive element according to an input voltage, comprising:
a first constant-current source for supplying a current from a first power supply to the capacitive element;
a second constant-current source for supplying the current from the capacitive element to a second power supply;
a first comparative device for comparing the input voltage with an output voltage to be supplied to the capacitive element;
a second comparative device for comparing the input voltage with a predetermined reference voltage; and
a control device for charging or discharging the capacitive element through the first power supply or the second power supply based on the result of the comparison of the second comparative device, charging or discharging the capacitive element through the first constant-current source or the second constant-current source based on the result of the comparison of the first comparative device, and holding a charging voltage of the capacitive element when the charging voltage of the capacitive element reaches the input voltage.

2. The driving circuit for driving a capacitive element according to claim 1, further comprising:
a first switching device for opening and closing a path between the first constant-current source and the capacitive element;
a second switching device for opening and closing a path between the second constant-current source and the capacitive element;
a third switching device for opening and closing a path between the capacitive element and the first power supply; and
a fourth switching device for opening and closing a path between the capacitive element and the second power supply;
wherein the control device controls the opening and closing of the third switching device and the fourth switching device based on the result of the comparison of the second comparative device to charge or discharge the capacitive element through the first power supply or the second power supply, controls the opening and closing of the first switching device and the second switching device based on the result of the comparison of the first comparative device to charge or discharge the voltage of the capacitive element through the first constant-current source or the second constant-current source, and holds the charging voltage of the capacitive element when the charging voltage of the capacitive element reaches the input voltage.

3. The driving circuit for driving a capacitive element according to claim 2, wherein the first comparative device comprises a switched comparator including an inverter and a capacitor which holds a differential voltage between the input voltage and a logical threshold voltage of the inverter.

4. The driving circuit for driving a capacitive element according to claim 2, wherein the second comparative device comprises an inverter for inverting the input voltage and analog switches for supplying and not supplying the inverter with an input signal.

5. The driving circuit for driving a capacitive element according to claim 2, wherein the reference voltage is a midpoint potential between the first power supply and the second power supply.

6. The driving circuit for driving a capacitive element according to claim 2, wherein the first comparative device comprises a switched comparator including a variable logical threshold inverter.
